(19) United States
(12) Patent Application Publication
(10) Pub. No.: US 2025/0158132 A1
(43) Pub. Date: May 15, 2025

(54) FOLDING METHOD FOR ASSEMBLING AND/OR STACKING SOLID STATE BATTERIES, AND MULTI-CELL SOLID STATE BATTERIES MADE USING THE METHOD

(71) Applicants: Arvind KAMATH, Los Altos, CA (US); Khanh TRAN, San Jose, CA (US)

(72) Inventors: Arvind KAMATH, Los Altos, CA (US); Khanh TRAN, San Jose, CA (US)

(73) Assignee: Ensurge Micropower ASA, Oslo (NO)

(21) Appl. No.: 18/946,887

(22) Filed: Nov. 13, 2024

Related U.S. Application Data
(60) Provisional application No. 63/598,912, filed on Nov. 14, 2023.

(51) Int. Cl. H01M 10/0583; H01M 10/0525

(52) U.S. Cl. CPC H01M 10/0583; H01M 10/0525

(57) ABSTRACT

A folded solid-state battery cell stack and a method of making the same are disclosed. The folded battery cell stack includes a flexible substrate and solid-state battery cells thereon. Each battery cell includes a cathode on or over the substrate, a solid-state electrolyte on the cathode, an anode current collector (ACC) on the solid-state electrolyte, an insulator layer on the ACC and having a sidewall portion, and a conductive redistribution layer on the insulator layer, including the sidewall portion, in ohmic contact with the ACC. The substrate includes a bend between adjacent solid-state battery cells, and the redistribution layer along the sidewall portion of each solid-state battery cell is aligned with other redistribution layers along other sidewall portions in the stack. The method includes forming the cells on the substrate and folding the substrate at a gap between adjacent solid-state battery cells.

### CROSS-REFERENCE TO RELATED APPLICATIONS

This application claims the benefit of U.S. Provisional Pat. Appl. No. 63/598,912, filed Nov. 14, 2023, pending, incorporated herein by reference in its entirety.

### FIELD OF THE INVENTION

The present invention generally relates to the field of solid-state and/or thin film batteries. More specifically, embodiments of the present invention pertain to methods of making stacked and/or multi-cell solid-state batteries, and multi-cell solid-state batteries made using the method.

### DISCUSSION OF THE BACKGROUND

Solid-state lithium batteries are ionic-charge storage devices that are ideally suited for wearable, IoT, and other non-EV applications due to their small size, safety, and high cyclability. It is desirable to simplify assembly (e.g., to reduce costs) as well as increase volumetric energy density of such batteries.

Some solid-state battery cells are fabricated on sheets or rolls, then packaged into an appropriate form-factor product. A common form-factor is cylindrical. In this case, cells are cut into strips, then wound as rolls and placed inside a metal casing with external contacts. For minimizing volume and maximizing energy density, an alternative form-factor may involve packaging the cells by cutting and stacking or attaching them directly in parallel to form a battery of desired capacity. This form is conducive to fabricating smaller capacity (micro-) batteries, and it has dimensional flexibility (e.g., in Cartesian or “x-y-z” dimensions) appropriate for particular end-uses or applications, such as being narrow-tall for in-ear products, vs. large-flat for on-body electronic wearable products. One drawback of stacking/attaching a multiplicity of cells is the requirement to fully singulate each cell, then pick-n-place (PnP) one cell on or over another cell, with relatively high alignment accuracy.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to stacked and/or multi-cell solid-state batteries, and more specifically to a folding-based method for making and/or assembling such solid-state batteries. This invention eliminates the need for singulating individual battery cells and for pick-and-place (PnP) stacking of micro-batteries on a thin substrate, resulting in (a) lower capital costs, (b) faster manufacturing cycle times, (c) lower material and handling costs, (d) lower inventories (e.g., numbers of units, as well as types of units), and (e) solid-state micro-batteries with higher volumetric energy densities.

A further innovation of this disclosure simplifies the singulation process, avoids any need for single die PnP tooling, and reduces or substantially eliminates cell-to-cell alignment inaccuracies. Another major benefit is that some of the cell edges may not be exposed in the final packaging, enabling the battery to be potentially more hermetic or resistant to external gas (e.g., oxygen) and moisture ingress.

Accordingly, one aspect or the present invention relates to a folded solid-state battery cell stack, comprising a flexible substrate and a plurality of solid-state battery cells on the substrate. Each of the solid-state battery cells comprises a cathode on or over the substrate, a solid-state electrolyte on the cathode, an anode current collector (ACC) on the solid-state electrolyte, an insulator layer on the ACC, and a conductive redistribution layer on the insulator layer. The insulator layer has (i) a sidewall portion on a sidewall of each of the ACC, the solid-state electrolyte, the cathode and the substrate and (ii) an opening exposing a surface of the ACC. The redistribution layer is (1) in ohmic contact with the ACC and also (2) on the sidewall portion of the insulator layer. The substrate includes a bend between adjacent solid-state battery cells, such that the adjacent solid-state battery cells are face-to-face or back-to-back (e.g., alternatingly). The redistribution layer along the sidewall portion of each solid-state battery cell is aligned with the other redistribution layer(s) along other sidewall portion(s) of the solid-state battery cells.

For example, when the substrate includes a row of n cells thereon (here n is an integer of 4 or more), after folding, the first cell and the second cell adjacent thereto may be face-to-face, the second cell and the third cell adjacent thereto may be back-to-back, the third cell and the fourth cell adjacent thereto may be face-to-face, etc. Thus, successive adjacent cell pairs along the direction of substrate folding may alternate face-to-face and back-to-back configurations.

The more cells that are in the stack, the higher the capacity of the battery. Thus, the folded stack includes a single row or column of two (2) or more cells. For example, the folded stack can include 4, 6, 8 or more cells (e.g., in multiples of 2), up to 10, 12, 16, 20, 24, 28, 32, 40, 50, 100 or more cells.

In some embodiments, the substrate comprises a metal foil, film or sheet. The metal foil, film or sheet may have a thickness of 0.1-100 μm. Generally, the metal foil, film or sheet supporting the solid-state battery cells is continuous. Additionally or alternatively, the bend (e.g., in the substrate, in the gap between adjacent battery cells) comprises a score between the adjacent solid-state battery cells. When the folded solid-state battery cell stack includes four or more of the solid-state battery cells in series, the substrate may include a plurality of the scores. In some examples, the scores comprise a first score between face-to-face solid-state battery cells and a second score between back-to-back solid-state battery cells. In such examples, the first score and the second score have different widths to accommodate optimal folding, depending on the thicknesses of the substrate and the composite battery cell layers (e.g., the sum of the cathode, solid-state electrolyte, anode current collector, insulator, and redistribution layer thicknesses). The thicker structure (i.e., the substrate vs. the composite battery cell layers) may determine the relative widths of the first and second scores in order to enable folding the cells evenly, uniformly, and/or flush over one another.

In many embodiments, the folded solid-state battery cell stack further comprises an adhesive layer between faces or backs of the adjacent solid-state battery cells. For example, when the folded solid-state battery cell stack comprises a row, column or series of four or more solid-state battery cells, it may also comprise a plurality of the adhesive layers. The adhesive layers are between the faces of the adjacent solid-state battery cells, or between the backs of the adjacent solid-state battery cells. In some embodiments, the adhesive layers are only between the faces of the adjacent solid-state battery cells, or only between the backs of the adjacent solid-state battery cells.

Another aspect of the present invention concerns a packaged solid-state battery cell, comprising the present folded solid-state battery cell stack, a first terminal (e.g., an anode) in electrical contact with the conductive redistribution layer on the sidewall portion of the insulator layer, and a second terminal (e.g., a cathode) in electrical contact with an exposed surface (e.g., a sidewall surface) of the substrate. The packaged solid-state battery may further comprise an adhesive layer between at least two of the adjacent ones of the solid-state battery cells. For example, when the folded solid-state battery cell stack comprises a row, column or series of four or more solid-state battery cells, the packaged solid-state battery may also comprise a plurality of the adhesive layers between the faces or the backs of the adjacent solid-state battery cells, as for the folded solid-state battery cell stack.

A further aspect of the present invention concerns a method of making a solid-state battery cell stack, comprising forming a plurality of solid-state battery cells on a flexible substrate, and folding the substrate at a gap between adjacent ones of the solid-state battery cells along a first dimension (e.g., of the substrate) to form the solid-state battery cell stack, such that the adjacent solid-state battery cells are face-to-face or back-to-back. Each of the solid-state battery cells comprises a cathode on or over the substrate, a solid-state electrolyte on the cathode, an anode current collector (ACC) on the solid-state electrolyte, an insulator layer on the ACC, and a conductive redistribution layer on the insulator layer, including the sidewall portion. The insulator layer has (i) a sidewall portion on a sidewall of each of the ACC, the solid-state electrolyte, the cathode and the substrate, and (ii) an opening exposing a surface of the ACC, and the redistribution layer is in ohmic contact with the ACC (e.g., in the opening in the insulator layer). The redistribution layer along the sidewall portion of each solid-state battery cell in the solid-state battery cell stack is aligned with the other redistribution layer(s) along other sidewall portion(s) of the solid-state battery cells.

As for the present folded solid-state battery cell stack, the substrate may comprise a metal foil, film or sheet having a thickness of 0.1-100 μm in the present method. The method may further comprise scoring the metal foil, film or sheet in the gap(s) between the adjacent solid-state battery cells. For example, when the plurality of solid-state battery cells comprises four or more of the solid-state battery cells, there are generally a plurality of the gaps, and the method may comprise forming (i) a first score in one or more of the gaps between the adjacent solid-state battery cells that are face-to-face after folding the substrate, and (ii) a second score in one or more of the gaps between the adjacent solid-state battery cells that are back-to-back after folding the substrate. The first score may have a first width different from a second width of the second score.

In embodiments of the present method including four or more of the solid-state battery cells along the first dimension, the method may further comprise applying an adhesive layer to a face or a back of every other one of the solid-state battery cells. Additionally or alternatively, the present method may further comprise compressing the solid-state battery cell stack (e.g., using a relatively low positive pressure) and/or curing the adhesive.

A still further aspect of the present invention concerns a method of making a packaged solid-state battery cell, comprising the present method of making the solid-state battery cell stack, forming a first terminal in electrical contact with the conductive redistribution layers on the sidewall portions of the insulator layers, and forming a second terminal in electrical contact with an exposed surface of the substrate. The exposed surface of the substrate is generally a sidewall surface opposite from the sidewall surface having the redistribution layers thereon. As for other aspects of the present invention, the present method of making the packaged solid-state battery cell may further comprise applying an adhesive layer to a face or a back of at least one of the adjacent ones of the solid-state battery cells. For example, the method may comprise applying the adhesive layer to the face or the back of every other one of the solid-state battery cells.

Other capabilities and advantages of the present invention will become readily apparent from the detailed description of various embodiments below.

### BRIEF DESCRIPTION OF THE DRAWINGS

FIGS. 1-5, 6A, 7A and 8A are cross-sectional views and FIGS. 6B, 7B and 8B are top-down or plan views of various structures in an exemplary method of manufacturing multi-cell pair solid-state battery strips, according to embodiments of the present invention.

FIG. 9 is a layout view of a sheet of multi-cell solid-state battery strips following the exemplary method illustrated in FIGS. 1-8B, according to one or more embodiments of the present invention.

FIG. 10 is cross-sectional view of a singulated battery cell strip following pre-fold scoring, according to one or more embodiments of the present invention.

FIGS. 11A-B are cross-sectional views of different embodiments of the battery cell strips following strip singulation with a printed adhesive thereon, according to embodiments of the present invention.

FIGS. 12A-B respectively show cross-sections of cells in the same array as the cells in FIGS. 11A-B, but along an orthogonal direction, according to embodiments of the present invention.

FIGS. 13A-B are cross-sectional views of the folded battery cell strips of FIGS. 12A-B, according to embodiments of the present invention.

FIGS. 14A-B are cross-sectional views of exemplary packaged solid-state batteries according to one or more embodiments of the present invention.

FIGS. 15A-B show cross-sectional and plan (top-down) views of a singulated battery cell strip according to one or more alternative embodiments of the present invention.

FIG. 16 shows a completely folded multi-cell battery stack according to the alternative embodiment(s) of the present invention.

FIG. 17 shows an opaque end view of a packaged solid-state battery according to the alternative embodiment(s) of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present invention concerns a stacked or folded multi-cell solid-state battery and methods of making the same. The present solid-state battery includes, in some embodiments, an intrinsic anode-less battery comprising a substrate (e.g., a metal foil substrate, which can also serve or function as a cathode current collector [CCC]), a cathode or cathode layer, a solid-state electrolyte (SSE) or solid-state electrolyte layer, and an anode current collector (ACC). In anode-less embodiments, no lithium anode is formed between the SSE and the ACC during manufacturing. A lithium anode may form during and/or upon completion of a battery charging operation.

The following discussion provides an example of a manufacturing process for stacked and/or multi-cell solid-state batteries, as well as variations of the process.

### An Exemplary Method of Making a Solid-State Battery

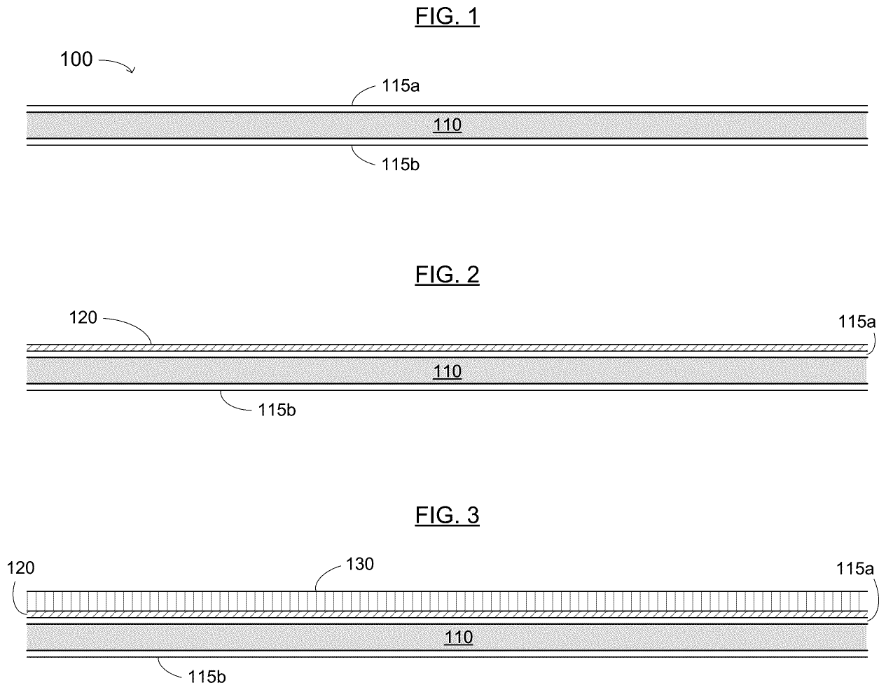

FIGS. 1-8B show certain structures in an exemplary method of making multi-cell pair solid-state battery strips. FIG. 1 shows a substrate 100, comprising a metal foil, sheet or film 110 and optional first and second barriers 115a-b on opposite major surfaces of the metal foil, sheet or film 110. When the foil, sheet or film 110 is a metal foil, the first and second barriers 115a-b are not optional. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the sheet or film can also be a metal sheet or metal roll. For example, the foil, sheet or film may be 0.10-100 μm thick, although the invention is not so limited. Other alternative substrates include a metal coating, such as aluminum, copper, nickel, titanium, etc., on a mechanical substrate, such as a removable plastic film, sheet or roll.

The barrier 115a-b comprises one or more layers of one or more materials in a thickness effective to prevent migration of atoms or ions from the metal foil, sheet or film 110 into overlying layers. The barrier material(s) may comprise a glass or ceramic, such as silicon dioxide, aluminum oxide, silicon nitride, a silicon and/or aluminum oxynitride, etc., or a (refractory) metal nitride, such as aluminum nitride, titanium nitride, titanium aluminum nitride, tungsten nitride, titanium tungsten nitride, tantalum nitride, etc., or an amorphous metal or metal alloy, such as a TiW alloy. In some embodiments, each of the first and second barriers 115a-b comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier 115a or 115b, whether a single layer or multiple layers, may have a total thickness of 0.05-3 μm, but the barrier 115 is not limited to this range. The barriers 115a-b may be blanket-deposited onto the foil, sheet or film 110 by chemical or physical vapor deposition (e.g., sputtering, thermal evaporation, atomic layer deposition [ALD], etc.), solution-phase coating with a precursor material followed by annealing to form the glass/ceramic or metal nitride, etc. Exemplary barrier materials, structures and thicknesses and methods for their deposition are disclosed in U.S. Pat. Nos. 9,299,845 and 11,742,363 and U.S. patent application Ser. No. 17/012,010, filed Sep. 3, 2020 (Atty. Docket No. IDR5320), the relevant portions of each of which are incorporated by reference herein.

In some embodiments, the foil, sheet or film 110 functions as a cathode current collector. In such embodiments, at least the barrier 115a (and optionally the barrier 115b) is a conductive, amorphous material, such as the refractory metal nitrides listed above or an amorphous metal alloy (e.g., a TiW alloy).

FIG. 2 shows the metal substrate 100 with a cathode 120 thereon. The cathode 120 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode 120 may be blanket deposited by laser deposition (e.g., pulsed laser deposition or PLD), sputtering, chemical vapor deposition (CVD), sol-gel processing, etc. Alternatively, the cathode 120 may be selectively deposited by screen printing, inkjet printing, spray coating, or extrusion coating (e.g., using an ink comprising one or more sol-gel precursors and one or more solvents, having a viscosity appropriate for the printing or coating technique).

FIG. 3 shows a solid-state electrolyte 130 on the cathode 120. The electrolyte 130 may comprise or consist essentially of a conventional lithium phosphorus oxynitride (LiPON, which may optionally be carbon-doped) or Li₂WO₄, a good Li-ion conductor. Alternatively, the electrolyte 130 may comprise lithium lanthanum zirconium oxide (LLZO). Typically, the electrolyte 130 is a continuous layer or thin film. In some embodiments, the electrolyte 130 may further comprise optional cathode and/or anode interface layers (not shown), each of which may comprise a lithiated metal oxide (see, e.g., U.S. Pat. No. 11,735,791, the relevant portions of which are incorporated herein by reference).

Forming the electrolyte 130 may comprise depositing a LiPON layer or a tungsten oxide layer of the formula WO₃₊ₓ (0≤x≤1) by sputtering, optionally using pulsed DC power. When the electrolyte 130 comprises LiPON, it may be deposited by RF sputtering or ALD. The sputtering target may comprise a Li₃PO₄ or mixed graphite-Li₃PO₄ target, the latter of which may contain 1-15 wt % of graphite, when the electrolyte 130 comprises LiPON or carbon-doped LiPON, and a metallic/elemental tungsten target when the electrolyte 130 comprises a tungsten oxide. In the latter case, sputtering is performed in an oxygen or oxygen-containing atmosphere. The method of making the electrolyte 130 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 100). Thermal annealing may comprise heating at a temperature of 150-500° C. for a length of time of 5-240 minutes, or any temperature or length of time therein (e.g., 250-450° C. for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100° C. for at least 10 minutes (e.g., to transform it into Li₂WO₄).

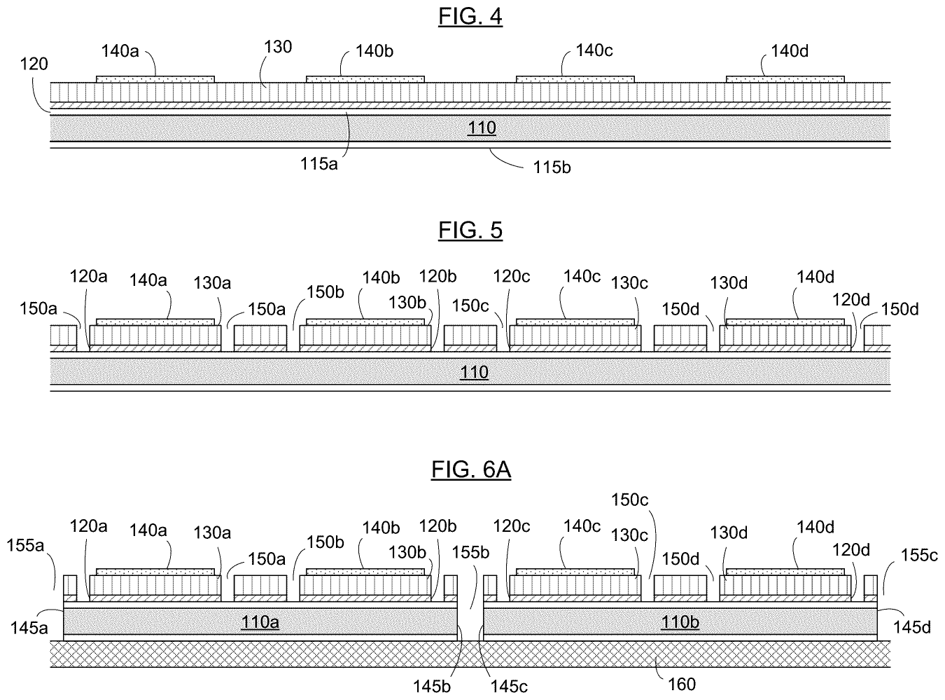

FIG. 4 shows a number of anode current collectors (ACCs) 140a-d on the electrolyte 130, thus forming substantially complete (but unsealed) cells. A separately-formed anode is not necessary in solid-state lithium batteries, as a lithium anode can be formed between the electrolyte 130 and the anode current collectors 140a-d during charging, if necessary. Optionally, however, a thin lithium anode can be deposited by evaporation onto the electrolyte 130 prior to formation of the anode current collectors 140a-d.

The anode current collectors 140a-d generally comprise a conductive metal, such as nickel, zinc, copper, alloys thereof (e.g., NiV), etc., or another conductor, such as graphite. The anode current collectors 140a-d can be selectively deposited by screen printing, inkjet printing, spray coating, etc. Typically, the printed anode current collectors 140a-d are cured by irradiating with ultraviolet (UV) light, heating (e.g., up to a temperature of about 550° C., but more commonly, up to about 400° C.), or a combination thereof. Alternatively, the anode current collectors 140a-d may be formed by blanket deposition (e.g., sputtering or evaporation) and patterning (e.g., low-resolution photolithography, development and etching). The anode current collectors 140a-d may have a thickness of 0.1-5 μm, although it is not limited to this range.

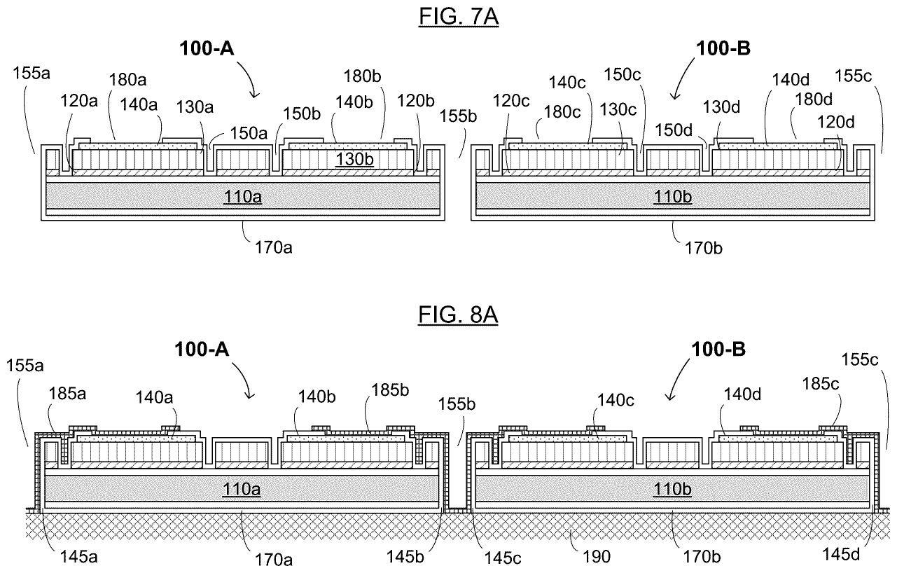

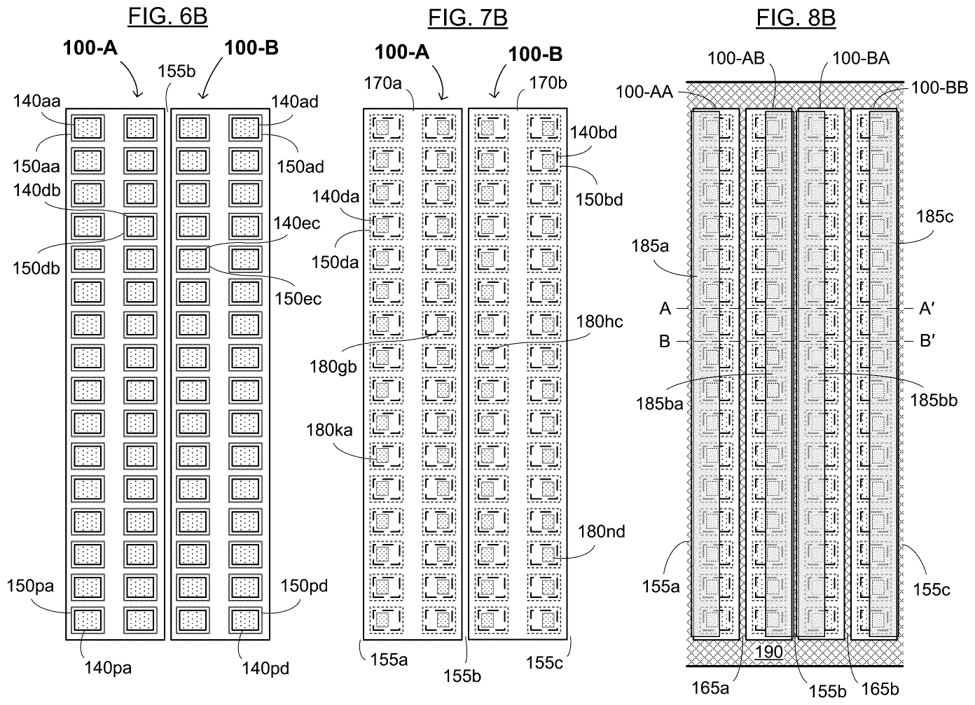

The anode current collectors 140a-d may have area dimensions (i.e., length and width dimensions) that are 50-95% of the corresponding length and width dimensions, respectively, of the cell (see e.g., FIG. 8), although the borders of the anode current collectors 140a-d may be offset (pulled back) a minimal distance from the ultimate cell borders, in some embodiments. The pull-back distance of the ACCs 140a-d from the cell edges should be sufficient to electrically isolate the ACCs 140a-d from the CCC/substrate 100. FIG. 4 shows four (4) anode current collectors 140a-d, representing two strips of multiple cell pairs (e.g., as seen in a corresponding layout view, such as that shown in FIGS. 6B and 8B).

The cells may further include one or more interlayers that modify the interfaces between layers. For example, a metal oxide (e.g., Nb₂O₅, Al₂O₃, Li₄Ti₅O₁₂ or LiNbO₃) interlayer may be formed on the cathode 120 prior to deposition of the electrolyte 130 (e.g., to reduce interfacial stress, decrease interfacial resistance, or suppress formation of a space charge layer). An amorphous (e.g., elemental silicon) interlayer may be deposited on the electrolyte 130 prior to formation of the anode current collectors 140a-d to inhibit reduction of the electrolyte. Of course, the battery cell can be made in the reverse order (i.e., the anode current collector may be first formed on the substrate, then the remaining layers deposited in reverse order thereon).

An advantage of the present method is that some/all of the active battery layers (e.g., the cathode 120 and the solid-state electrolyte 130) are deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers. However, if necessary or desired, the cathode 120 and the SSE 130 can be slightly pulled back from the cell edge by subtractive patterning (e.g., low-resolution photolithography, laser ablation) or selective deposition (as described herein).

FIGS. 5 and 6A-8B show intermediate structures in a process for moat formation (optional), ACC-edge electrical isolation and cell encapsulation, and formation of an interconnect/via and redistribution layer for contact with the anode current collector 140. After cell fabrication as described above, FIG. 5 shows the devices receiving a shallow cut 150a-d through both of the cathode 120 and the solid-state electrolyte 130 (and optionally slightly into the substrate 100) outside of the ACCs 140a-d to form moats 150a-d that completely surround the respective ACCs 140a-d. When the ACCs 140a-d extend into the area or region where the moats 150a-d are formed, moat formation removes the peripheral portions of the ACCs 140a-d that extend into the area or region of the moats 150a-d. In the present invention, however, the moats 150a-d and their formation are optional.

The moats 150a-d may be formed by laser ablation, mechanical dicing, or low-resolution photolithographic patterning (e.g., of a photoresist or other mask material) and etching. The moats 150a-d may have a width of 3-20 μm, although the invention is not limited to such widths. The moats 150a-d provide an anchoring feature for cell encapsulation (see the discussion below with regard to FIG. 7) and physically separate the active portion(s) of the battery layers from a peripheral dummy region. When the moats 150a-d extend into the substrate 100, they fully isolate the active cathode and electrolyte layers 120 and 130. Each of these aspects of the moats 150a-d increases resistance to ambient ingress.

Referring to FIG. 6A, the substrate 100 is on or attached to a substrate support 160, and the electrolyte 130, the cathode 120 and the substrate 100 are cut or diced along the “ACC edges” 145a-d of the battery cells to form an opening 155a-c every other row or column of cells (when the cells are in an array on a sheet, or on a multi-column/multi-row roll). When the substrate support 160 is a tape or sheet, the tape or sheet 160 is generally a UV release tape or sheet, containing an adhesive on one or both major surfaces that loses its adhesive properties upon sufficient irradiation with ultraviolet (UV) light. The tape or sheet 160 may be on a ring or other frame, configured to mechanically support the tape or sheet 160 and allow some tension therein and some light to pass through the underside of the tape or sheet. When the substrate support 160 is substrate holder (e.g., for cutting or dicing by stamping), it may comprise a magnetic plate or chuck.

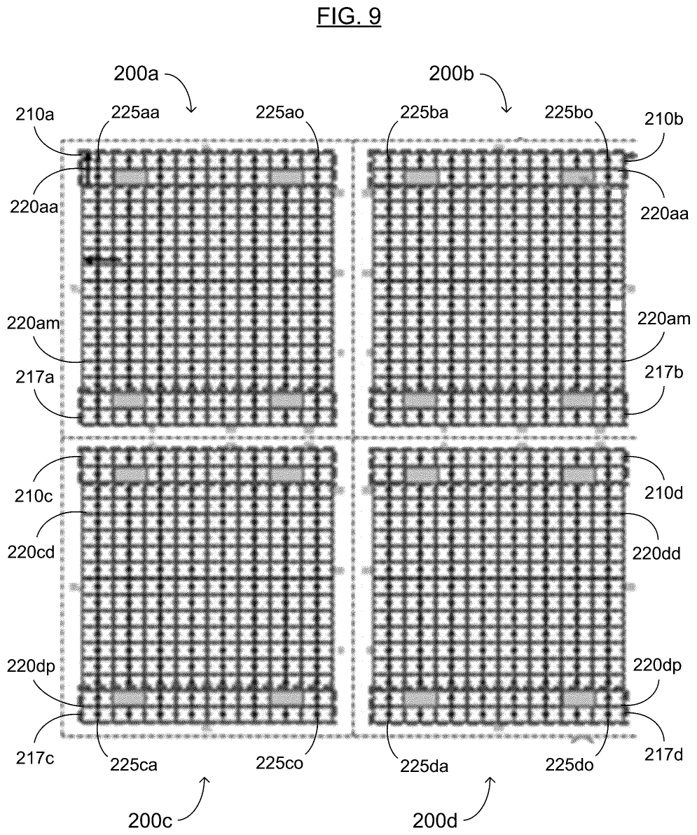

The ACC cell edges 145a-d may be cut by laser (e.g., laser ablation), mechanical dicing or stamping, for example. Examples of a method of mechanical stamping of the electrolyte 130, the cathode 120 and the substrate 100 are disclosed in U.S. patent application Ser. No. 18/885,525, filed Sep. 13, 2024 (Atty. Docket No. IDR2022-06), the relevant portions of which are incorporated by reference herein. The sidewalls 145a-d along the cuts fully expose the entire cell stack, including the CCC/substrate 110. In a further option, the electrolyte 130, the cathode 120 and the substrate 100 between adjacent moats 150 not containing an ACC 140 may be cut or diced (see, e.g., FIG. 9, which shows the further cuts resulting in “CCC edges” 125), but the timing of the cuts to form the CCC edges 125 is not essential. When the cells are in an array or on a multi-column roll, they may also be cut or diced along the horizontal or x-direction in FIG. 6 between adjacent cells (e.g., every column, or every row) to form isolated cell pairs.

FIG. 6B shows a layout or plan view of the battery cells in FIG. 6A, as cell pair strips 100-A and 100-B. (The substrate support 160 is not shown in FIG. 6B.) As shown in FIG. 6B, the moats 150aa-pd may completely surround the respective ACCs 140aa-pd. Alternatively, when the ACCs 140a-d are deposited or otherwise formed as strips (e.g., continuously along cell columns a-d), the moats 150 may be formed in parallel outside of the ACC strips 140a-d, along the length of the ACC strips 140a-d.

Referring now to FIG. 7A, after the diced cell pair strips 100-A and 100-B are released from the tape or sheet 160, the cell pair strips 100-A and 100-B are covered (e.g., topside, corners and sidewalls) or substantially encapsulated (e.g., as shown) with a mechanically compliant moisture barrier and electrical insulation film 170a-b. The barrier/insulation film 170a-b also lines the inner surfaces of the moats 150a-d to provide further electrical isolation and moisture barriers to protect the battery cells. The barrier/insulation film 170a-b may cover the front (top) or uppermost surface of the cells, the “ACC” side surface 145a-d of the cells (e.g., in the openings 155a-c) and optionally, the backside surface of the cells. The barrier/insulation film 170a-b may be printed (e.g., by inkjet printing or screen printing) onto the cells.

The barrier/insulation film 170a-b may comprise parylene, polyethylene, polypropylene, or another polyolefin, with or without a thin (and optionally printable) inorganic oxide or nitride overlayer such as Al₂O₃, SiO₂ (e.g., formed by heating a tetraalkyl silicate such as tetraethyl orthosilicate [TEOS]) or Si₃N₄ (e.g., a parylene/Al₂O₃ bilayer). The barrier/insulation film 170a-b may be formed by pyrolysis, thermal CVD, ALD, inkjet printing, or screen printing. Additionally, the barrier/insulation film 170a-b may be coated with a polycarbonate or a diamond-like (e.g., amorphous carbon) coating for additional mechanical protection. Alternatively, encapsulation with the moisture barrier and electrical insulation film 170a-b may be performed after dicing the strips of cell pairs into individual cell pairs, and optionally releasing the cell pairs from a tape or sheet (not shown). The barrier/insulation film 170a-b thus may cover all exposed front, back and side surfaces of the cell pairs or strips of cell pairs. The material(s) of the barrier/insulation film 170a-b may be dissolved or suspended in an appropriate solvent (e.g., an organic solvent, as described elsewhere herein) prior to printing. In certain embodiments, after printing, the material for the barrier/insulation film 170a-b may be cured (e.g., by irradiation with ultraviolet light) to provide certain desirable properties (e.g., hardness, optical properties, adhesion, etc.).

One advantage of printing to form the barrier/insulation film 170a-b is that an opening 180a-d may be formed on each cell over the ACC 140 during printing, without any need for additional processing (such as laser ablation, photolithographic patterning, etc.) to form the openings. Another advantage of printing is that, if further cuts resulting in “CCC edges” 125 are made, such edges can be selectively not covered with the barrier/insulation film 170a-b by simply not printing the barrier/insulation film 170a-b on those edges. However, if the barrier/insulation film 170a-b completely covers or encapsulates the diced cell pair strips, the openings 180a-d may be formed in the barrier/insulation film 170a-b in each cell over the ACC 140 by laser ablation, photolithographic patterning and etching, etc.

The cell pair strips 100-A and 100-B are more clearly seen in FIG. 7B, with the opening 155b between the strips. Each cell pair strip 100-A includes a plurality of cell pairs, with the ACCs 140xa-xb and the moats 150xa-xb (x is the row label a through p) shown in dashed lines, as they are covered by the insulation film 170a. Similarly, each cell pair strip 100-B includes a plurality of cell pairs, with the ACCs 140xc-xd and the moats 150xc-xd (x is the row label a through p) shown in dashed lines, as they are covered by the insulation film 170b. The openings 180aa-pd expose the uppermost/outermost surface of the ACCs 140aa-pd.

FIG. 8A shows formation of redistribution metal layers 185a-c along the ACC edges 145a-d (e.g., in the openings 155a-c) and in vias or openings 180a-d in the barrier/insulation film 170a to connect the ACCs 140a-d to a subsequently formed external battery terminal. The redistribution layers 185a-c may comprise Cu, Ni, Al, or another suitable and/or stable (e.g., air- and/or water-stable, and/or lithium-compatible) metal, and may be formed by sputtering, ALD, or other blanket deposition technique, followed by photolithographic patterning and etching; thermal evaporation (e.g., through a mask that exposes a region of the cell corresponding to the pattern of the redistribution layers 185a-c, followed by removal of the mask); or by selective deposition, such as inkjet printing, aerosol-jet printing, screen printing, extrusion coating, etc. Printing may comprise use of a conventional metal-containing ink or paste. To facilitate deposition or printing of the redistribution layers 185a-c, the battery cell pairs or strips of battery cell pairs may be placed on a holder 190, such as a magnetic plate, chuck or other substrate carrier.

Low electrical resistance and a low curing temperature is desirable for the redistribution layers 185a-c, and the redistribution layers 185a-c have a thickness typically in the range 0.25-2 μm on the uppermost surface of the cells. For example, regardless of how the redistribution layers 185a-c are deposited, the redistribution layers 185a-c may be cured (e.g., by heating or sintering, optionally after drying in the case of printing an ink or paste) at a temperature of 150-550° C., or any temperature or range of temperatures therein (e.g., 150-350° C.), for a length of time sufficient to convert the deposited material to a conductive metal. Due to liquid flow, the entireties of the vias or openings 180a-d may be filled with metal, which may be beneficial during battery cycling. When the moats 150 are present, deposition of the redistribution layers 185a-c by printing, sputtering, or thermal evaporation may also fill the portions of the moats 150 nearest to the ACC edges 145a-d with metal, facilitating the ingress-barrier function of the moat 150 along the ACC edge 145.

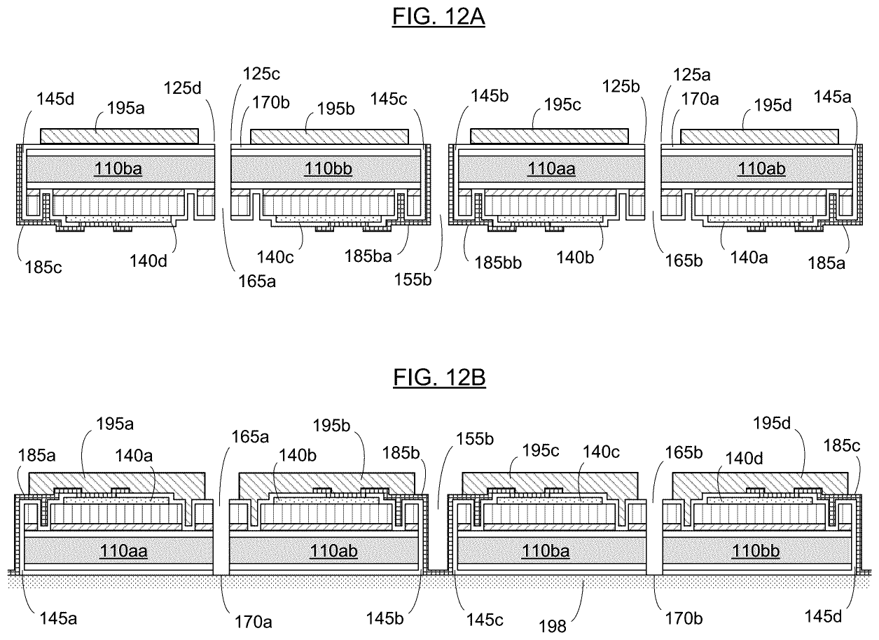

As shown in FIG. 8A, a single redistribution layer (e.g., 185b) is on the ACC edges 145b-c of adjacent cells in different strips (e.g., 100-A and 100-B). The redistribution layers (or ACC redistribution traces) 185a-c go from the ACCs 140a-d exposed through the vias or openings 180a-d to the ACC edges 145a-d, in the opposite direction from the CCC edges 125a-d (FIG. 12A). In FIG. 8B, the redistribution layer 185b is separated, broken or otherwise divided into redistribution layers 185ba and 185bb, which can happen naturally or inherently during processing, as there is little or nothing to maintain continuity of the redistribution layer 185b at the bottom of the opening or channel 155b. Alternatively, the redistribution layers 185 can be formed in only the cell pairs adjacent to each other across the opening or channel 155b (e.g., containing ACCs 140ab-ac, 140bb-bc, etc.) by selective deposition. However, it is advantageous for the redistribution layers 185 to completely cover the vias or openings 180.

The ACC redistribution traces 185a-c electrically contact the ACCs 140a-d through the vias 180a-d, but are physically and electrically insulated from the CCCs/substrates 110a-b by the barrier/insulation films 170a-b. When the ACC redistribution traces 185a-c are a metal or alloy (e.g., an amorphous alloy), they form an intrinsic barrier to ambient ingress in the region of the vias or openings 180a-d/180aa-pd. The ACC redistribution traces 185a-c are both physically on the top surface of the cell and covering at least part of the corresponding sidewalls 145a-d. The ACC redistribution traces 185a-c on the sidewalls 145a-d enable electrical connection to the cells through a terminal or tab on the side of the battery at a later stage of the method.

In one embodiment, the method comprises printing both the insulator for the barrier/insulation film 170a-b and the metal for the ACC redistribution traces 185a-c, using dual (separate) inkjet printer heads. Preferably, the materials for the barrier/insulation film 170a-b and the ACC redistribution traces 185a-c are printed separately, with an optional curing step between the separate printing steps, if necessary or desired, although they may be printed simultaneously in some cases (e.g., where the solvents for the different layers are immiscible). This allows for faster cycle times and more efficient use of capital for manufacturing equipment.

In some embodiments, cells that fail testing (e.g., due to shorts or leakage) prior to formation of the ACC redistribution traces 185a-c (e.g., after formation of the moats 150a-d or ACC edge sidewalls 145a-d) are left without electrical connections to the ACC 140a-d (e.g., no ACC redistribution trace 185 is formed in that cell), but will still be incorporated into the stack (i.e., the folded multi-cell battery). These cells will be fully encapsulated with the insulator 170, and may have connecting metal 185 on the barrier/insulation film 170, but the metal redistribution trace 185 will not be formed in the via 180. In such embodiments, the yield of functional/performing battery cells in the front end (e.g., up to FIG. 6) is advantageously greater than or equal to 95%, so as to minimize volumetric energy loss from non-performing cells.

The cell dimensions may be selected according to the cell or battery footprint, and the battery capacity may be determined by the target cell capacity times either (i) the number of cells that pass testing divided by the number of cells in each stack, or (ii) the number of cells in each stack times the percentage of cells that pass testing.

FIG. 9 shows a layout view of four arrays 200a-d of battery cells on a sheet or roll. Each array of battery cells includes a plurality of rows or strips 210a-d through 217a-d of battery cell pairs. For example, each row or strip of cell pairs 210a-d through 217a-d comprises a 2×n strip of cells, where n is the number of cell pairs in the strip. Alternatively, each of the rows or strips 210a-d may include a strip of single cells (e.g., a 1×n strip of cells) or a strip of cells that is 3 or more cells wide (e.g., an m x n strip of cells, where m is an integer of 3 or more). Within each row or strip of cells, a partial moat or score may be formed or cut between the cells to facilitate folding of the substrate between the cells. The cells are not separated except at the ends of the strip and between adjacent strips.

In one example, vertical lines 225ao-doin the battery cell arrays 200a-d represent the folding lines for the battery cell stacks, and horizontal lines 220aa-dp in the battery cell arrays 200a-d represent score lines between rows of cells, similar to those forming the openings 155a-c in FIGS. 6A-8B. The score lines 220a-d are made between each row of cells in the battery cell arrays 200a-d. The battery cell arrays 200a-d include a number of rows defined in part by the array dimensions and in part by the battery cell dimensions. As shown in FIG. 9, each array 200a-d includes 17 rows, but any integer number of rows of one or more is possible.

In this example, alternating horizontal lines 220 represent anode and cathode edges of each cell, respectively, and the redistribution traces are formed across every other vertical line 225. For example, in array 200a, horizontal lines 220aa, 225ac, 225ae, etc. represent the anode edges of the cells, and horizontal lines 220ab, 225ad, 225af, etc. represent the cathode edges of the cells. Alternatively, when the redistribution traces are oriented orthogonally (i.e., across every other horizontal line 220), alternating vertical lines 225 can represent the anode and cathode edges of each cell. For example, in array 200a, vertical lines 225aa, 225ac, 225ae, 225ag, 225ai, 225ak, 225am and 225ao may be the folding lines on the anode edges of the cells, and vertical lines 225ab, 225ad, 225af, 225ah, 225aj, 225al and 225an may be the folding lines on the cathode edges of the cells.

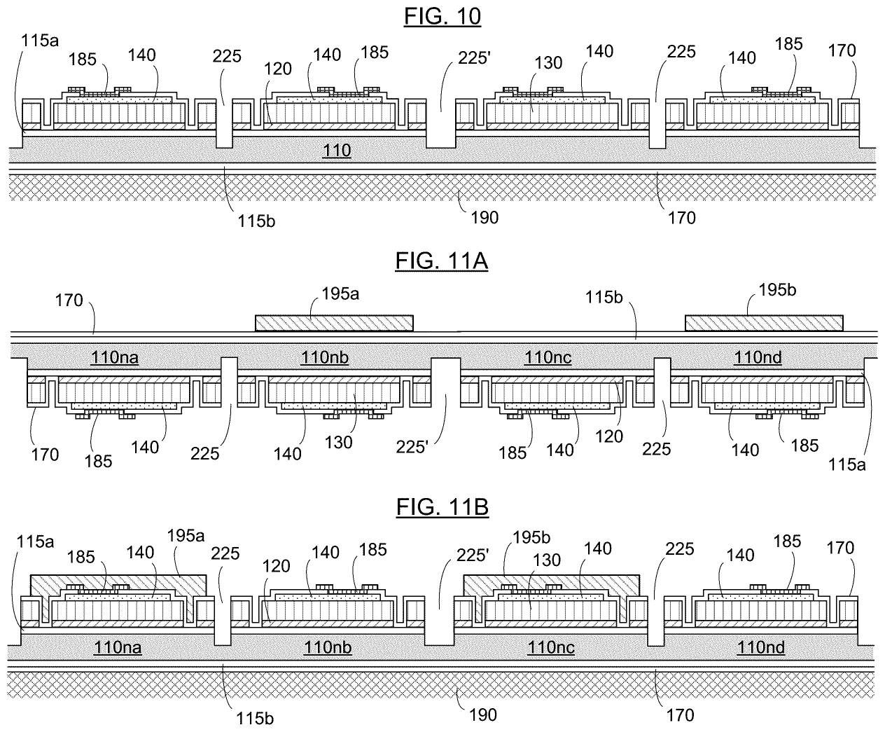

FIG. 10 shows a cross-section of four (4) battery cells in series along one row in an array of battery cells as shown in FIG. 9, separated by partial moats or scores 225 and 225′ (not drawn to scale). Typically, the partial moats or scores 225 and 225′ are formed completely through the battery cell layers 120-140 and the upper barrier layer 115a, and partially through (e.g., into, but not completely through) the metal foil substrate 110. The partial moats or scores 225 and 225′ may have a depth into the metal foil substrate 110 of 0-50% of the thickness of the metal foil substrate 110, although the invention is not limited to such depths. The partial moats or scores 225 and 225′ alternate, depending on the direction of the bend (e.g., face-to-face, vs. back-to-back). The partial moats or scores 225′ are typically wider than the partial moats or scores 225, as the partial moats or scores 225′ are for face-to-face bends (i.e., in which the redistribution layers 185 and insulator layers 170 face each other after the bend), whereas the partial moats or scores 225 are for back-to-back bends (i.e., in which the lower barrier layer 115b and/or substrate 110 face each other). Typically, the partial moats or scores 225 have a width that is about 3-10 times the maximum height of the stack of battery cell layers on the upper barrier layer 115a (e.g., the cathode 120, the electrolyte 130, the ACC 140, the insulator layer 170 and the redistribution layer 185), and the partial moats or scores 225′ have a width that is about 6-15 times the maximum height of the stack of battery cell layers on the upper barrier layer 115a, although the invention is not limited to such widths. For example, the maximum height of the stack of battery cell layers is 3 μm, or any height less than 3 μm (e.g., 2 μm, 1.5 μm, 1 μm, etc.). In some embodiments, the stack of battery cell layers has a height of 1-2 μm.

In this case, each row of battery cells will form one or more folded stacks of battery cells. The example shown in FIG. 9 includes 16 cells in each row. Thus, each row of cells in the battery cell arrays 200a-d can form one stack of 16 cells, two stacks of eight cells each, four stacks of four cells, two stacks of six cells and one stack of four cells, or any other combination of stacked cells that add up to 16 total cells and that include at least two cells in each stack. Of course, rows with a different number of cells therein will give rise to different possible combinations of cells in each stack. Ultimately, the number of cells in each stack depends on the capacity (e.g., in mAh) of each cell and the target or desired capacity of the packaged battery (e.g., after folding and terminal formation, as described below).

As shown in FIG. 9, each of the cells may have a square or rectangular shape in the plan/layout view. However, other shapes are also possible (e.g., parallelepiped, trapezoidal, hexagonal, octagonal, stadium [a so-called “pill shape” or discorectangle], etc.) as long as they can be cut into strips and folded. Thus, in some embodiments, the shape of each cell in the plan/layout view has two parallel lines along which the cells on each side are folded. To ensure that the folds align in a manner facilitating subsequent formation of the battery electrodes (i.e., the cathode and anode), the two parallel lines on opposite sides of each cell are equally spaced from each other, at least for each cell in a particular stack.

Along each of the vertical lines 225aa-do and in each row of cells are optional diamond-shaped orientation notches. The orientation notches can be present in a different pattern (e.g., every other row or column, every fourth row or column, etc., optionally offset by one or more rows and/or columns), may be placed in a different location (e.g., at an interface between cells in a column, at an intersection between four cells), and may have a different shape (e.g., circular, oval, square, rectangular, etc.). As shown, at the end of each row, the orientation notches have half of the full shape (e.g., a triangle), but other geometries and placements are also possible.

An adhesive may optionally be printed on the cells, in the event adhesion between adjacent cells helps to meet requirements for cell stack rigidity (e.g., for minimizing losses during packaging). For example, FIG. 11A shows the series of battery cells of FIG. 10 in a row or strip with an adhesive 195a-b printed on alternating “non-functional” surfaces of the substrate 110na-nd, and FIG. 11B shows the same row or strip of battery cells with an adhesive 195a-b printed on the uppermost surface of alternating cells. “Non-functional” refers to the lack of functional battery structures or layers on the underside of the substrate 110, as shown in FIGS. 2-8. FIGS. 12A-B respectively show cells in the same array as the cells in FIGS. 11A-B, but along an orthogonal (e.g., the column) direction. For example, the adhesive 195a-b may have a target thickness of <1 μm. For example, the thickness of the adhesive (either target or final) may be in the range of 20-500 nm, or any thickness or range of thicknesses <1 μm (e.g., 50-300 nm).

In both cases (top-side and bottom-side adhesive), and referring to both FIGS. 11A-B and FIGS. 12A-B, the adhesive 195a-d is preferably a thermosetting adhesive such as an epoxy adhesive, but other thermosetting and thermoplastic adhesives, such as (unsaturated) polyesters, polyimides, phenolic adhesives, polyamides, cyanoacrylates, polyacrylates, polymethacrylates, polyvinyl acetate (PVA) and copolymers thereof may also be suitable. Typically, the adhesive 195a-b is screen printed onto the battery cell surface, but other printing techniques, such as inkjetting, and other application techniques, such as stamping, spraying, extrusion coating, etc., can also be used.

If the uncured adhesive has a viscosity that is undesirably high for the printing technique and/or target thickness of the adhesive 195a-d, an amount of an organic solvent (e.g., an alkane, cycloalkane, arene, alkyl arene, ether, cyclic ether, or haloalkane solvent having a boiling point of about 150° C. or less) sufficient to adjust the viscosity for the printing technique and/or target thickness may be added. When the adhesive is a thermosetting adhesive, the composition to be printed may further include a curing agent (which may be activated by heat, for example a temperature of 80-200° C.). When the adhesive is a radiation-curable adhesive (e.g., an adhesive that is cured by irradiation with ultraviolet [UV] light), there should be a path for the radiation (e.g., light) to reach the adhesive.

Bottom-side printing of the adhesive is shown in FIGS. 11A and 12A. In such embodiments, the adhesive can adhere completely between planar non-functional surfaces, and spacing and uniformity of the stacked cells can be easily optimized. FIGS. 11A and 12A show an example in which adhesive is printed only in the area of alternating cells, which can also be done in top-side printing (FIGS. 11B and 12B).

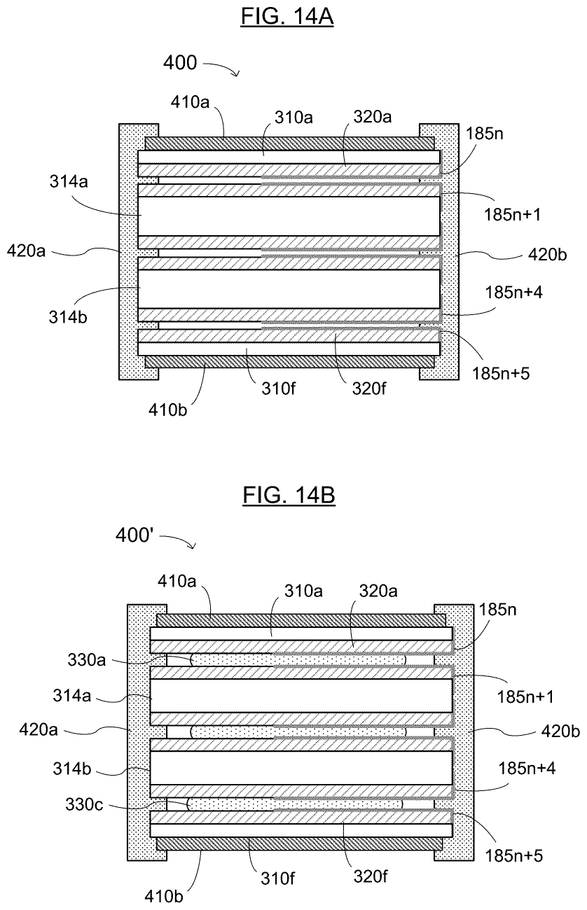

In some embodiments, the adhesive 195a-d is first applied to the cells prior to scoring between the cell pairs to form openings 165a-b (FIGS. 12A-B). Such scoring, which may be performed as described herein for openings 155a-c (e.g., by laser ablation, mechanical dicing, low-resolution patterning and etching, etc.; see the discussion of FIG. 6 above), exposes the CCC edges 125a-d and singulates the individual strips. The metal foil substrate sections 110aa-bb function as the cathode current collector (CCC) for each battery cell. The exposed edges 125a-d of the CCCs 110aa-bb are the interface to and/or electrical contact surface for a subsequent battery cathode (see, e.g., FIGS. 14A-B), and the redistribution layers 185aa-bb along the ACC edges 145a-d are the interface to and/or electrical contact surface for a subsequent battery anode.

In either top-side or bottom-side adhesive printing, the printed adhesive may have a length and/or a width that is 80-95% of the length and/or width of the die/cell, respectively, leaving 5-20% of the die along two or more edges uncovered. Such embodiments can avoid having to cut uncured or partially-cured adhesive during singulation, thereby minimizing cleaning and/or maintenance of the singulation equipment. However, such embodiments still provide sufficient coverage of the die/cell for the adhesion function and the air/water ingress prevention function of the adhesive to work.

In other embodiments, the adhesive 195a-d is applied to the cells after singulating the individual strips. However, as shown in FIGS. 11B and 12B, when in a pre-cured or partially cured state, the adhesive 195a-d can flow into any depressions in or above the ACC redistribution traces 185a-c in the vias or openings 180a-d, as well as any openings in the moats 150a-d. Eliminating voids or trapped gasses in such depressions and in the moats 150a-d can provide benefits during cycling (e.g., preservation of electrical contact with the ACCs 140a-d).

In FIGS. 11A-B and 12A-B, the redistribution layer 185b between cell pairs (i.e., between adjacent ACC edges 145b and 145c; see FIG. 8) is severed. However, an advantage of top-side printing is that the same holder can be used for printing the encapsulation 170, the redistribution layer 185, and the adhesive 195, in which case the redistribution layer 185b may not necessarily be severed in FIGS. 11B and 12B.

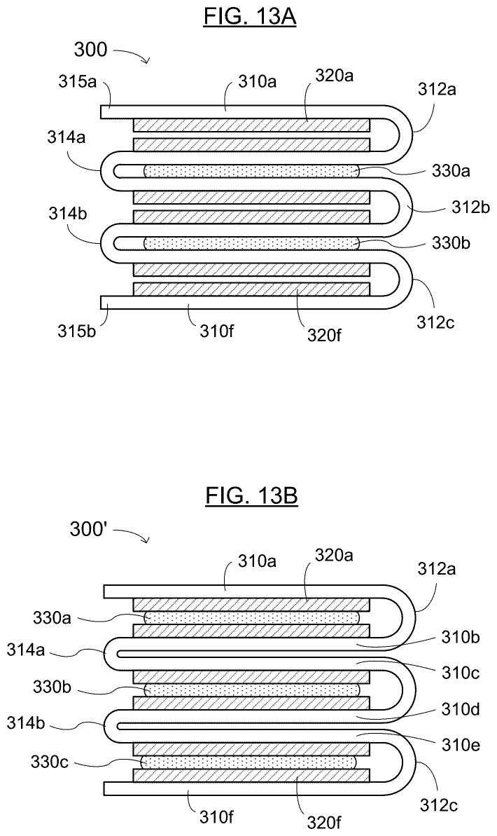

FIGS. 13A-B show side views or cross-sections of folded, multi-cell battery stacks 300 and 300′, respectively. FIG. 13A shows the example of FIG. 12A, in which the adhesive 330a-b is applied to the backside (non-functional surface) of the metal foil substrate 310, and thus, the adhesive 330a-b is between sections 310b-c and 310d-e of the metal foil substrate 310. FIG. 13B shows the example of FIG. 12B, in which the adhesive 330a-c is applied to the frontside (uppermost surface) of the battery cells 320a-f, and thus, the adhesive 330a-c is between battery cells 320a-b, 320c-d and 320e-f, respectively. In either case, the substrate 310 with the battery cells 320a-f thereon can be folded as shown in FIGS. 13A-B using an automated substrate folding tool, such as a Z-folding accordion machine. Z-folding accordion machines generally make alternating folds in an object (in this case, the metal foil substrate 310) in opposite directions (e.g., first folds 312a-c in a face-to-face direction, and second folds 314a-b in a back-to-back direction, simultaneously or repetitively, as desired), oftentimes so that the folded edges on each side of the folded object are aligned. For example, the Z-folding accordion machine may comprise a buckle folder, a knife folder, or a combination thereof. Following folding, the folded battery cell stacks 300/300′ may be compressed under a relatively low positive pressure (e.g., 0.12-1 MPa, or any pressure or range of pressures therein), although the invention is not limited to this range.

As can be seen in FIG. 13A, backside adhesive application has the advantage of increasing the length of the arc of the back-to-back folds 314a-b in the metal foil substrate 310, thereby reducing the risk of weaknesses or breaks forming in the metal foil substrate 310 in or near the back-to-back folds 314a-b. Optionally, a spacer (not shown) can be placed on alternate (e.g., every other) battery cells 320a-f or on the same surface of the metal foil substrate 310 as the battery cells 320a-f to protect the battery cells 320a-f from damage due to compression during the folding process, or due to lithium anode formation during cell charging. To ensure alignment of the unfolded ends 315a-b of the metal foil substrate 310 with the folds 312 and/or 314, the first and last sections 310a and 310f of the metal foil substrate 310 may have a slightly greater length or width than the other sections 310b-e of the metal foil substrate 310.

As can be seen in FIG. 13B, frontside adhesive application has the advantage of avoiding any need for the spacer, as the adhesive also provides the same function(s) as the spacer. In the multi-cell stack 300′, the back-to-back folds 314a-b are relatively short, and the substrate sections 310b and 310d may contact the substrate sections 310c and 310e in part or in whole, thereby minimizing the height of the multi-cell stack 300′ (depending on the numbers of cells and layers of adhesive). However, the risk of weaknesses or breaks in the metal foil substrate 310 in or near the back-to-back folds 314a-b is higher in frontside adhesive application than in backside adhesive application (FIG. 13A).

Battery terminal dipping/coating and plating the stacked set of cells 300 and 300′ forms external electrical contacts 420a-b, as shown in FIGS. 14A-B. The packaged batteries 400 and 400′ in FIGS. 14A-B include the multi-cell battery stacks 300 and 300′ in FIGS. 13A-B, rotated 90° around a vertical axis in the plane of the page in FIGS. 13A-B, through the center of the stacks 300 and 300′. For example, FIGS. 14A-B show the side/edge of the multi-cell battery stacks 300 and 300′ containing the back-to-back folds 314a-b, which block the view of the adhesive 330a-b (FIG. 13A) between facing sections of the metal foil substrate 310 in FIG. 14A, but not the adhesive 330a-c between facing battery cells 320a-f in FIG. 14B.

As shown in FIG. 14A, the electrical contact 420b is in contact with the redistribution (ACC) layers 185n through 185n+5, and thus forms at least part of the anode of the battery 400. The electrical contact 420a is in contact with the exposed sidewall surfaces of the metal foil substrate sections 310a-f (FIG. 13A), and thus forms at least part of the cathode of the battery 400.

Prior to terminal dipping/coating and plating, the outermost major surfaces of the battery cell stack 300/300′ may be covered with a protective layer 410a-b (FIGS. 14A-B). The protective layer 410a-b may comprise a coated metal foil substrate (e.g., similar or identical to the metal foil substrate 110 coated with one or more generally non-conductive barrier layers 115a-b), a non-conductive adhesive layer, or a combination thereof.

End terminals at the CCC and ACC edges of the battery cells 320a-f (e.g., the exposed edges of the metal foil substrate 310 and the redistribution layers 185n through 185n+5, respectively) are dipped into or coated with a conductive epoxy to electrically gang the terminals and form the CCC and ACC terminals 420a-b of the packaged battery 400/400′. The conductive epoxy may comprise an Ag-filled or Ni-filled conductive epoxy paste. Alternatively, a pin-to-pin paste transfer method may be used, or a stable and/or noble metal such as Au, Pt, Pd or Cu can be used in place of the Ag or Ni. Plating a metal onto part or all of the CCC and ACC terminals 410a-b creates a solderable surface for PCB attachment by the end user. For solderable termination, the epoxy surface may be plated with Ni, Ag, In, Sn, or a combination thereof (e.g., Ni, then with In or Sn).

In some embodiments, the conductive epoxy 420a-b contains a relatively high metal content, which can retard ambient ingress (e.g., of oxygen or water vapor). The epoxy 420a-b may be plated with one or more pure metal layers, to further block ambient ingress. Both of these features help with ambient air resistance, particularly on the CCC edge, due to the barrier/insulation film 170 being diced at this edge during cell singulation from the cell pairs (FIGS. 12A-B).

As is seen in FIGS. 14A-B, one end/side of the folded multi-cell battery stack 300/300′ exposes sidewall surfaces of the battery cells 320a-f, and should be covered. For example, in the frontside adhesive application example shown in FIG. 14B, the adhesive 330a-c (FIG. 13B) between the facing battery cells 320a-f is visible, but in FIG. 14A, the adhesive 330a-b (FIG. 13A) between facing sections of the metal foil substrate 310 is obscured by the back-to-back folds 314a-b. In one embodiment, the protective layers 410a-b are integral with a sidewall section of the same material, thus forming a U-shaped piece that both (i) protects the outermost surfaces of the folded metal foil substrate 310 and (ii) forms a hermetic seal along the side/end of the multi-cell battery stack 300/300′ that would otherwise expose sidewall surfaces of the battery cells 320a-f. The integral protective layers 410a-b and sidewall section may comprise a non-conductive or insulator-coated metal, an organic thermoplastic or thermoset polymer (e.g., a non-conductive epoxy, polyethylene, polypropylene, etc.), an adhesive-coated paper, a combination or laminate thereof, etc.

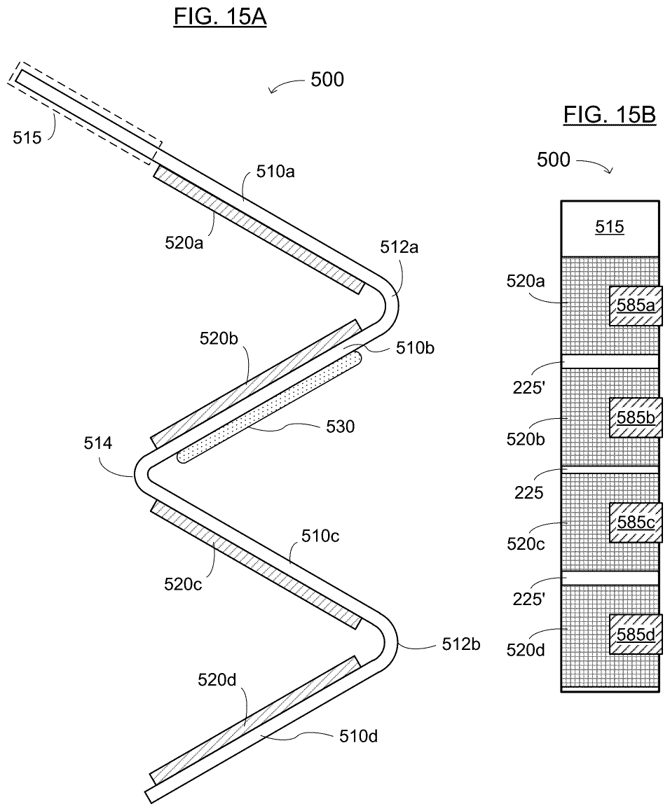

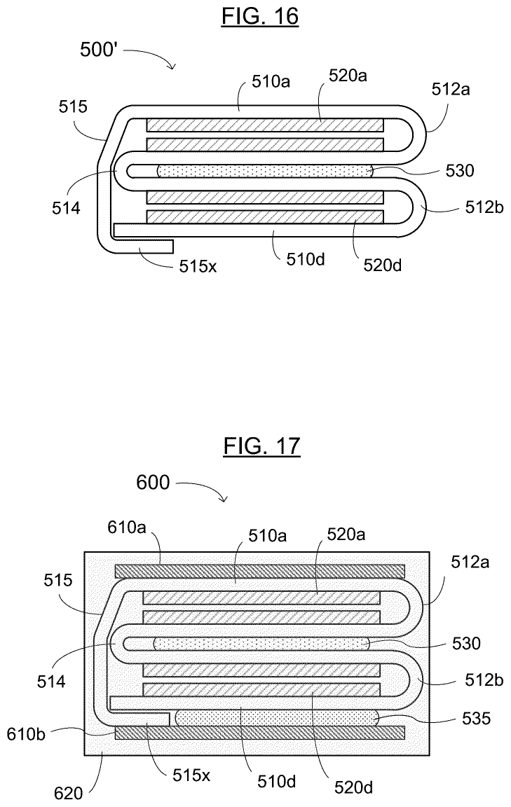

FIGS. 15A-17 show an alternative approach to ganging the cell current collector terminals for the battery cathode and anode. For example, FIGS. 15A-B show a series of four (4) battery cells 520a-d on corresponding sections 510a-d of a partially-folded metal foil substrate. The metal foil substrate further includes a dummy section 515 extending from the first substrate section 510a. The dummy section 515 may comprise a barrier- and insulator-coated section of the metal foil substrate 310, and optionally, one or more battery cell layers (electrically unconnected to at least one of the battery terminals, for example by omitting the redistribution layer) may be included. The dummy section 515 has a length greater than the height of the stacked battery cells (see, e.g., multi-cell battery stack 500 in FIG. 16). The series of battery cells 520a-d may contain an integer number of more or less than four (4) as described elsewhere herein, but generally at least two (2) cells. The adhesive 530 is on the non-functional surface of substrate section 510b, and thus was applied by a backside adhesive application process.

As shown in FIG. 15B, the redistribution layers 185a-d are exposed along the ACC edges of the battery cells 520a-d and provide an ACC-anode contact interface along one edge of the strip 500. The opposite edge of the strip 500 includes the exposed CCC interfaces of the cells (i.e., the exposed side surfaces of the metal foil substrate sections 510a-d). Upon folding, the ACC-anode contact interfaces and the exposed CCC interfaces are aligned along opposite sides of the stacked battery cells. Because folds 512a-b (FIG. 15A) are face-to-face folds, relatively wide scores 225′ are made in the substrate (FIG. 15B), and because fold 514 is a back-to-back fold, a relatively narrow score 225 is made in the substrate.

The folding may not occur as shown in FIG. 15A. For example, the fold 512b may be made completely or substantially completely (e.g., so that substrate sections 510c and 510d are at or substantially at an angle of 180° with respect to each other) before any other folds are made, then the fold 514 may be made completely before any further folds are made. After all folds are made, the stack of cells may be compressed (e.g., at a relatively low positive pressure as described herein) to ensure contact of the adhesive with an opposite surface and/or to reduce the thickness of the adhesive and/or the battery stack.

FIG. 16 shows a completely folded multi-cell battery stack 500. The dummy section 515 is wrapped around the back-to-back fold 514 and the opposite end of the substrate (e.g., the part of the metal foil substrate section 510d extending beyond the battery cell 520d opposite from the bend 512b). For example, after making the Z-folds or accordion folds 512a-b and 514, the Z-folding accordion machine or a separate C-folding and/or right angle folding machine may make a C-fold or (effectively) two right angle folds around sides of the metal foil sections 510b-d and the back-to-back fold 514 using the dummy section 515.

The terminal portion 515x of the dummy section 515 may be (and preferably is) in physical contact with the non-functional surface of the substrate section 510d. In some embodiments (e.g., when the battery stack 500 includes an even number of battery cells 510), the length of the terminal portion 515x that overlaps with the lowermost substrate section 510d is 10-80% of the length of the substrate section 510d, or any percentage or range of percentages therein, although the invention is not limited to this range. Alternatively (e.g., when the battery stack 500 includes an odd number of battery cells 510), the length of the terminal portion 515x may be 101-120% of the length of the substrate section 510d, or any percentage or range of percentages therein, although the invention is not limited to this range, either. When the battery stack 500 includes an odd number of battery cells 510, the terminal portion 515x having a length greater than the length of the lowermost substrate section 510 ensures complete coverage of any battery cell 520 on the lowermost substrate section 510 that would otherwise be exposed during packaging. The bent/folded dummy section 515 may also be in physical contact with the outermost surface of the back-to-back fold 514 and, when the terminal portion 515x has a length greater than that of the lowermost substrate section 510, one or more of the front-to-front folds 512a-b. The same configurations and methods also work for the multi-cell battery stack folded using a frontside adhesive (e.g., FIG. 13B).

FIG. 17 shows an opaque end view of a packaged battery 600. The only component that is actually visible in the end view is the electrode 620. The electrode 620 is either a cathode or an anode as described herein (e.g., comprising a conductive epoxy and an optional conductive metal plated thereon), depending on the battery cell interfaces contacting the electrode 620. The other electrode is on the opposite side/edge of the battery stack 500 (i.e., behind the plane of the page in FIG. 17). The battery cells are effectively and/or hermetically sealed by the folded metal foil substrate 510, including the folded dummy cell 515, and the electrodes 620.

Prior to formation of the electrodes 620, the outermost major surfaces of the battery cell stack 500′ (FIG. 16) may be covered with a protective layer 610a-b, similarly to the protective layer 410a-b described with reference to FIGS. 14A-B. However, in the packaged battery 600 of FIG. 17, the protective layer 610b on the same major surface as the terminal portion 515x of the dummy section 515′ may be secured to the exposed outer surface of the lowermost substrate section 510d with a second nonconductive adhesive 535. The second nonconductive adhesive 535 may be selected from the nonconductive adhesives disclosed herein. The second nonconductive adhesive 535 also functions at least in part as a spacer to improve the uniformity of the physical dimensions of the battery cell stack 500′ (FIG. 16) and/or the packaged battery 600 (FIG. 17).

### CONCLUSION

The invention provides a packaged multi-cell solid-state battery that eliminates any need for singulating individual battery cells and/or for pick-and-place (PnP) stacking of microbatteries on a purely mechanical substrate, resulting in (a) lower capital costs, (b) faster manufacturing cycle times, (c) lower material and handling costs, and (d) lower inventories (e.g., numbers of units, as well as types of units). The invention may further provide solid-state microbatteries having relatively high volumetric energy densities. Even further, the invention simplifies the singulation process (e.g., only strips including multiple cells are singulated), and reduces or substantially eliminates cell-to-cell alignment inaccuracies. Another major benefit is that the cell edges may not be exposed in the final packaging, enabling the battery to be more hermetic or resistant to external gas (e.g., oxygen) and moisture ingress.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A folded solid-state battery cell stack, comprising:
a flexible substrate; and
a plurality of solid-state battery cells on the substrate, wherein each of the solid-state battery cells comprises:
a cathode on or over the substrate;
a solid-state electrolyte on the cathode;
an anode current collector (ACC) on the solid-state electrolyte;
an insulator layer on the ACC and having a sidewall portion on a sidewall of each of the ACC, the solid-state electrolyte, the cathode and the substrate, wherein the insulator layer exposes a surface of the ACC; and
a conductive redistribution layer on the insulator layer, including the sidewall portion, and in ohmic contact with the ACC;
wherein the substrate includes a bend between adjacent ones of the solid-state battery cells, such that the adjacent solid-state battery cells are face-to-face or back-to-back, and the redistribution layer along the sidewall portion of each of the plurality of solid-state battery cells is aligned with the redistribution layer along the sidewall portion of the others of the plurality of solid-state battery cells.

2. The folded solid-state battery cell stack of claim 1, wherein the substrate comprises a metal foil, film or sheet.

3. The folded solid-state battery cell stack of claim 2, wherein the metal foil, film or sheet has a thickness of 0.1-100 μm.

4. The folded solid-state battery cell stack of claim 2, wherein the metal foil, film or sheet is continuous, and the bend comprises a score between the adjacent solid-state battery cells.

5. The folded solid-state battery cell stack of claim 4, comprising a row of four or more solid-state battery cells and a plurality of the scores, wherein the scores comprise a first score between face-to-face solid-state battery cells and a second score between back-to-back solid-state battery cells, and the first score has a first width greater than a second width of the second score.

6. The folded solid-state battery cell stack of claim 5, wherein the folded solid-state battery cell stack has a maximum height, the first width is about 6-15 times the maximum height, and the second width is about 3-10 times the maximum height.

7. The folded solid-state battery cell stack of claim 1, further comprising an adhesive layer between faces or backs of the adjacent solid-state battery cells.

8. The folded solid-state battery cell stack of claim 7, comprising a row of four or more solid-state battery cells and a plurality of the adhesive layers.

9. The folded solid-state battery cell stack of claim 8, wherein the adhesive layers are between the faces of the adjacent solid-state battery cells.

10. The folded solid-state battery cell stack of claim 8, wherein the adhesive layers are between the backs of the adjacent solid-state battery cells.

11. A packaged solid-state battery cell, comprising:
the folded solid-state battery cell stack of claim 1;
a first terminal in electrical contact with the conductive redistribution layer on the sidewall portion of the insulator layer; and
a second terminal in electrical contact with an exposed surface of the substrate.

12. The packaged solid-state battery cell of claim 11, further comprising an adhesive layer between at least two of the adjacent ones of the solid-state battery cells.

13. A method of making a solid-state battery cell stack, comprising:
forming a plurality of solid-state battery cells on a flexible substrate with a gap between adjacent ones of the solid-state battery cells along a first dimension, wherein each of the solid-state battery cells comprises:
a cathode on or over the substrate;
a solid-state electrolyte on the cathode;
an anode current collector (ACC) on the solid-state electrolyte;
an insulator layer on the ACC and having a sidewall portion on a sidewall of each of the ACC, the solid-state electrolyte, the cathode and the substrate, wherein the insulator layer exposes a surface of the ACC; and
a conductive redistribution layer on the insulator layer, including the sidewall portion, and in ohmic contact with the ACC;
folding the substrate at the gap to form the solid-state battery cell stack, such that the adjacent ones of the solid-state battery cells are face-to-face or back-to-back, and the redistribution layer along the sidewall portion of each of the plurality of solid-state battery cells is aligned with the redistribution layer along the sidewall portion of the others of the plurality of solid-state battery cells.

14. The method of claim 13, wherein the substrate comprises a metal foil, film or sheet having a thickness of 0.1-100 μm.

15. The method of claim 14, further comprising scoring the metal foil, film or sheet in the gap between the adjacent solid-state battery cells.

16. The method of claim 15, wherein:
the plurality of solid-state battery cells comprises four or more of the solid-state battery cells and a plurality of the gaps, a first score in one or more of the gaps between the adjacent solid-state battery cells that are face-to-face after folding the substrate, and a second score in one or more of the gaps between the adjacent solid-state battery cells that are back-to-back after folding the substrate, and
the first score has a first width greater than a second width of the second score.

17. The method of claim 13, wherein the plurality of solid-state battery cells comprises four or more of the solid-state battery cells along the first dimension, and the method further comprises applying an adhesive layer to a face or a back of every other one of the plurality of solid-state battery cells.

18. The method of claim 17, further comprising compressing the solid-state battery cell stack, and curing the adhesive.

19. A method of making a packaged solid-state battery cell, comprising:
the method of claim 13;
forming a first terminal in electrical contact with the conductive redistribution layers on the sidewall portions of the insulator layers; and
forming a second terminal in electrical contact with an exposed surface of the substrate.

20. The method of claim 19, further comprising applying an adhesive layer to a face or a back of at least one of the adjacent ones of the solid-state battery cells.
